(19) United States
(12) Patent Application Publication
(10) Pub. No.: US 2013/0334045 A1
(43) Pub. Date: Dec. 19, 2013

(54) Distributable Chemical Sampling and Sensing System

(71) Applicants: Werner G Kuhr, Denver, CO (US); Craig Rhodine, Monument, CO (US)

(72) Inventors: Werner G Kuhr, Denver, CO (US); Craig Rhodine, Monument, CO (US)

(73) Assignee: ChemiSensor LLP, Monument, CO (US)

(21) Appl. No.: 13/795,318

(22) Filed: Mar. 12, 2013

Related U.S. Application Data
(60) Provisional application No. 61/659,873, filed on Jun. 14, 2012.

(51) Int. Cl. G01N 1/22; G01N 27/26

(52) U.S. Cl. CPC G01N 1/22; G01N 27/26
USPC 204/435; 73/863.11

(57) ABSTRACT

The present invention relates to a distributable sampling and sensing instrument for chemical analysis of consumable foods and other agricultural products. The distributed sampling system is used to separate and concentrate the chemicals of interest obtained from samples at remote locations via thermal desorption onto a detachable target substrate that can be analyzed on-site or off-site. The volatile components adsorbed onto the target substrate can be analyzed with specific sensors (e.g., electrochemical sensors) or the assembly can be sent to a central lab and analyzed with conventional chemical instrumentation (e.g., GC-MS). This instrument provides the capability to enable chemical analysis of a wide range of chemical species of interest in a wide range of environments and conditions.

### RELATED APPLICATIONS

This applications is a utility application of co-pending U.S. provisional patent application Ser. No. 61/659,873, filed Jun. 14, 2012 entitled “Distributable Chemical Sampling and Sensing System”, the disclosures of which are hereby incorporated by reference in their entirety.

### REFERENCES CITED

US PATENT DOCUMENTS

| | | |
|---|---|---|
| 4,438,207 | March 1984 | Fahrenholtz et al |
| 4,833,073 | May 1989 | McNally et al |
| 5,124,267 | June 1992 | Humpel et al |
| 5,144,030 | September 1992 | Wang et al |
| 5,219,747 | June 1993 | McNally et al |
| 5,264,373 | November 1993 | Wang et al |
| 5,302,703 | April 1994 | Buechler et al |
| 5,426,056 | June 1995 | Nacson |
| 5,463,027 | October 1995 | Wang et al |
| 5,726,435 | March 1998 | Hara et al |
| 5,817,766 | October 1998 | Hui et al |
| 5,910,419 | June 1999 | Johnson et al |
| 6,095,153 | August 2000 | Kessler et al |
| 6,605,444 B1 | August 2003 | Klein et al |
| 6,686,209 B2 | February 2004 | Wang et al |
| 6,761,164 B2 | July 2004 | Amirpour et al |
| 6,772,756 B2 | August 2004 | Shayan |
| 6,990,978 B2 | January 2006 | Shayan |
| 7,550,112 B2 | June 2009 | Gou et al |
| 7,564,027 B2 | July 2009 | Finch et al |
| 7,624,734 B2 | December 2009 | Balch et al |
| 7,749,772 B1 | June 2010 | Wang |
| 7,776,618 B2 | August 2010 | Nazareth et al |
| 7,790,400 B2 | September 2010 | Jehanali et al |
| 7,816,143 b2 | October 2010 | Day et al |
| 7,878,416 B2 | February 2011 | Lapstun et al |
| 8,071,394 B2 | December 2011 | Wu et al |
| 8,160,671 B2 | April 2012 | Kamath et al |
| 2004/0147767 A1 | July 2004 | Whittle et al |
| 2006/0281189 A1 | December 2006 | Minter |
| 2007/0163327 A1 | July 2007 | Mansoon |
| 2009/0294298 A1 | December 2009 | Compton et al |

FOREIGN PATENT DOCUMENTS

| | | |
|---|---|---|
| EP 0736529 A1 | March 1996 | Hui et al |
| WO 2005/066618 A1 | December 2004 | Compton et al |
| WO 2006/134386 | June 2006 | Compton et al |

### OTHER PUBLICATIONS

[1] B. Gilbert-Lopez, J. F. Garcia-Reyes and A. Molina-Diaz, “Sample treatment and determination of pesticide residues in fatty vegetable matrices: A review,” TALANTA, vol. 79, no. 2, pp. 109-128, 2009.
[2] M. LeDoux, “Analytical methods applied to the determination of pesticide residues in foods of animal origin. A review of the past two decades,” JOURNAL OF CHROMATOGRAPHY A, vol. 1281, no. 8, pp. 1021-036, 2011.
[3] K. Ridgway, S. P. D. Lalljie and R. M. Smith, “Sample preparation techniques for the determination of trace residues and contaminants in foods,” JOURNAL OF CHROMATOGRAPHY A, vol. 1153, pp. 36-53, 2007.
[4] P. Zollner, A. Leitner, D. Berner, M. Kleinova, J. Jodlbauer, B. Mayer and W. Lindner, “Improving LC-MS/MS analyses in complex food matrices, Part I—Sample preparation and chromatography,” LC GC EUROPE, vol. 16, no. 3, p. 163, 2003.
[5] C. Ferrer, M. Gomez, J. Garcia-Reyes, I. Ferrer, E. Thurman and A. Fernandez-Alba, “Determination of pesticide residues in olives and olive oil by matrix solid-phase dispersion followed by gas chromatography/mass spectrometry and liquid chromatography/tandem mass spectrometry,” JOURNAL OF CHROMATOGRAPHY A, vol. 1069, no. 2, pp. 183-194, 2005.
[6] F. Calbiani, M. Careri, L. Elviri, A. Mangia, L. Pistara and I. Zagnoni, “Development and in-house validation of a liquid chromatography-electrospray-tandem mass spectrometry method for the simultaneous determination of Sudan I, Sudan II, Sudan III and Sudan IV in hot chilli products,” JOURNAL OF CHROMATOGRAPHY A, vol. 1042, pp. 123-130, 2004.
[7] J. Hajslova and J. Zrostlikova, “Matrix effects in (ultra)trace analysis of pesticide residues in food and biotic matrices,” JOURNAL OF CHROMATOGRAPHY A, vol. 1000, pp. 181-197, 2003.
[8] H. Aramaki, “Forensic chemical study on Marihuana 1. A detection method of the principal constituents by thin-layer and gas chromatography,” Chemical and Pharmacological Bulletin, vol. 16, no. 5, pp. 822-826, 1968.
[9] K. D. Parker, “Rapport préliminaire sur la separation et la determination quantitative par la chromatographic sur couches minces et la chromatographic en phase gazeuse des constituents cannabiniques présents dans la plante ou ajoutés A l'urine,” Bulletin des stupéfiants, vol. 20, no. 4, pp. 7-12, 1968.
[10] R. A. de Zeeuw, T. M. Malingre and F. Merkus, “Δ-1-Tetrahydro-cannabinolic acid, an important component in the evaluation of cannabis products,” Journal of Pharmacy and Pharmacology, vol. 24, no. 1, pp. 1-6, 1972.
[11] M. R. Paris and R. R. Paris, “Importance de la chromatographic pour l'étude des constituents du cannabis sativa L,” Bulletin de la Sociétéchimique de France, vol. 1, pp. 118-122, 1973.
[12] C. E. Hadley and K. Turner, “Constituents of Cannabis sativa L. 11: Absence of cannabidiol in an African variant,” Journal of Pharmaceutical Sciences, vol. 62, no. 2, pp. 251-255, 1973.
[13] S. N. Sharma and J. D. Tewari, “Separation and identification of cannabinoids from Cannabis indica L. by thin-layer chromatography,” Pharmazie, vol. 34, no. 1, pp. 54-55, 1979.
[14] P. Oroszlan, “Separation, quantitation and isolation of cannabinoids from Cannabis sativa by overpressure layer chromatography,” Journal of Chromatography, vol. 388, no. 1, pp. 217-224, 1987.
[15] P. B. Baker, “Determination of the distribution of cannabinoids in cannabis resin using high-performance liquid chromatography,” Journal of Analytical Toxicology, vol. 4, pp. 145-152, 1980.
[16] C. G. Vaughan and R. N. Smith, “High-pressure liquid chromatography of cannabis: quantitative analysis of acidic and neutral cannabinoids,” Journal of Chromatography, vol. 129, pp. 347-354, 1976.
[17] S. L. Kanter, M. R. Musumeci and L. E. Hollister, “Quantitative determination of Δ-9-tetrahydrocannabinol and Δ-/9-tetrahydro-cannabinolic acid in marihuana by high-pressure liquid chromatography,” Journal of Chromatography, vol. 171, pp. 504-508, 1979.
[18] D. J. Harvey, “Chemistry, metabolism and pharmacokinetics of the cannabinoids,” in Marihuana in Science and Medicine, New York, Raven Press, 1984, pp. 37-107.
[19] D. Debruyne, “Identification et différenciation des chanvres résineux et textile: utilisation conjuguée de HPLC et GLC haute resolution,” Bulletin des stupéfiants, vol. 33, no. 2, pp. 45-54, 1981.
[20] I. Centini et al., “Packed-column chromatography, high-resolution gas chromatography and high-pressure liquid chromatography in comparison for the analysis of cannabis constituent,” Forensic Science International, vol. 21, no. 2, pp. 129-137, 1983.
[21] I. Nakahara, “Studies on confirmation of cannabis use. I. Determination of the cannabinoid contents in marijuana cigarette, tar, and ash using high-performance liquid chromatography with electrochemical detection,” Journal of Analytical Toxicology, vol. 9, no. 3, pp. 121-124, 1985.
[22] T. B. Vree, “Gas chromatography of cannabis constituents and their synthetic derivatives,” Journal of Chromatography, vol. 74, pp. 209-224, 1972.
[23] M. Novotny et al., “Analysis of marijuana samples from different origins by high resolution gas-liquid chromatography for forensic application,” Analytical Chemistry, vol. 48, no. 1, pp. 24-29, 1976.
[24] L. Stromberg, “Minor components of cannabis resin. VI. Mass spectrometric data and gas chromatographic retention times of components eluted after cannabinol,” Journal of Chromatography, vol. 121, pp. 313-322, 1976.
[25] D. J. Harvey, “Comparison of fourteen substituted silyl derivatives for the characterization of alcohols, steroids and cannabinoids by combined gas-liquid chromatography and mass spectrometry,” Journal of Chromatography, vol. 147, pp. 291-298, 1978.
[26] H. Spiteller and G. Grote, “Neue cannabinoide. II,” Journal of Chromatography, vol. 154, pp. 13-23, 1978.
[27] E. Commission, Community method for the quantitative determination of Δ9-THC (Tetrahydrocannabinol) content in hemp varieties. Off J Eur Comm L280:43-65: Commission Regulation (EC) No 2316/1999 laying down detailed rules for the application of Council Regulation (EC) No 1251/1999 establishing a support system for producers of certain arable crops, 1999.
[28] C. Arthur and J. Pawliszyn, Anal Chem, vol. 62, pp. 2145-2148, 1990.
[29] H. Kataoka, H. Lord and J. Pawliszyn, Journal of Chromatography A, vol. 880, p. 35-62, 2000.
[30] R. Smith, “High-pressure liquid chromatography of cannabis identification of separated constituents,” J. Chromatogr., vol. 115, pp. 101-106, 1975.
[31] S. Kanter, M. Musumeci and L. Hollister, “Quantitative determination of D9-tetrahydrocannabinol and D9-tetrahydrocannabinolic acid in marihuana by high pressure liquid chromatography,” J Chromatogr, vol. 171, p. 504-508, 1979.
[32] J. Turner and P. Mahlberg, “Effects of sample treatment on chromatographic analysis of cannabinoids in Cannabis sativa L. (Cannabaceae),” J. Chromatogr., vol. 283, p. 165-171, 1984.
[33] T. Veress, J. Szanto and L. Leisztner, “Determination of cannabinoid acids by high-performance liquid chromatography of their neutral derivatives formed by thermal decarboxylation process in an open reactor,” J. Chromatogr., vol. 520, p. 339-347, 1990.
[34] J. Parker and B. Stembal, “Review of gas-liquid chromatography of marihuana,” JAOAC, vol. 57, p. 888-892, 1974.
[35] S. Chang, C. Chen, F. Chin and H. Chang, “Qualitative and quantitative analysis of cannabinoids in Cannabis sativa, Huo-Ma-Jen and Agave Sisalan,” Chin Pharm J, vol. 49, pp. 77-80, 1997.
[36] G. Thakur, R. Duclos Jr. and A. Makriyannis, Life Sci, vol. 78, p. 454, 2005.
[37] C. Giroud, Chimia, vol. 56, p. 80, 2002.
[38] K. Hillig and P. Mahlberg, Am. J. Bot., vol. 91, p. 966, 2004.
[39] N. Doorenbos, P. Fetterman, M. Quimby and C. Turner, Ann. N.Y. Acad. Sci., vol. 191, p. 3, 1971.
[40] A. Stolker, J. van Schoonhoven, A. de Vries, I. Bobeldijk-Pastorova, W. Vaes and R. van den Berg, J. Chromatogr. A, vol. 1058, p. 143, 2004.
[41] E. R. Lowe, R. G. Compton and C. E. Banks, “Indirect detection of substituted phenols and cannabis based on the electrochemical adaptation of the Gibbs reaction,” Anal Bioanal Chem, vol. 383, p. 523-531, 2005.
[42] P. Josephy and A. Damme, Anal Chem, vol. 56, p. 813, 1984.
[43] N. Craft, G. Byrd and L. Hilpert, Anal Chem, vol. 61, p. 540, 1989.
[44] A. Goodwin, C. E. Banks and R. G. Compton, “Graphite Micropowder Modified with 4-Amino-2,6-diphenylphenol Supported on Basal Plane Pyrolytic Graphite Electrodes:MicroSensing Platforms for the Indirect Electrochemical Detection of D9-Tetrahydrocannabinol in Saliva,” Electroanalysis, vol. 18, no. 11, pp. 1063-7, 2006.
[45] C. Moore, A. Negrusz and D. Lewis, “Determination of drugs of abuse in meconium,” J Chromatogr B, vol. 713, p. 137-146, 1998.
[46] I. Breindah and K. Andreasen, “Determination of 11-nor-Δ9-tetrahydro-cannabinol-9-carboxylic acid in urine using HPLC and electrospray ionisation mass spectrometry,” J Chromatogr B, vol. 732, pp. 155-164, 1999.
[47] M. Weaver, B. Gan, E. Allen, L. Baugh, F. Liao, R. Liu, J. Langner, A. Walia and L. Cook, “Correlations on radioimmunoassay, fluorescence polarization immunoassay and enzyme immunoassay of cannabis metabolites with gas chromatography/mass spectrometry analysis of 11-nor-D9-tetrahydrocannabinol-9-carboxylic acid in urine specimens,” Forensic Sci Int, vol. 49, p. 43-56, 1991.
[48] M. Bacigalupo, A. Ius, G. Meroni, G. Grassi and A. Moschella, “Time-resolved fluoro-immunoassay for D9-tetrahydrocannabinol as applied to early discrimination of Cannabis sativa plants,” J Agric Food Chem, vol. 47, p. 2743-45, 1999.
[49] Ngen-Ngwainbi, et al., J. Am. Chem. Soc., vol. 108, pp. 5444-5447, 1986.
[50] B. S. Yu et al., “Electrochemical oxidation of phenol on metal oxide electrodes,” JOURNAL OF WATER CHEMISTRY AND TECHNOLOG, vol. 34, no. 1, pp. 24-27, 2012.
[51] D. W. Lachenmeier, L. Kroener, F. Musshoff and B. Madea, “Determination of cannabinoids in hemp food products by use of headspace solid-phase microextraction and gas chromatography-mass spectrometry,” Anal Bioanal Chem, vol. 378, p. 183-189, 2004.
[52] D. W. Lachenmeier, L. Kroener, F. Musshoff and B. Madea, “Determination of cannabinoids in hemp food products by use of headspace solid-phase microextraction and gas chromatography-mass spectrometry,” Anal Bioanal Chem, vol. 378, p. 183-189, 2004.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

There has been a dramatic increase in the need for the chemical analysis of food and agricultural products in recent years. This comes as a result of many factors, some which include increased use of pesticides and fungicides (especially in the developing world), increased regulation and taxation by local and federal governments as well as increased concern about contamination and adulteration of food products. Pest control in intensive agriculture involves treatment of crops (fruits, vegetables, cereals, etc.) pre- and post-harvests with a variety of synthetic chemicals generically known as pesticides. The resurgence of ‘organic’ foods in the last decade has spurred a closer examination of the pesticide and herbicide content of foods consumed. ‘Organic’ is a labeling term that refers to agricultural products produced in accordance with Organic Foods Production Act and the NOP Regulations. The principal guidelines for organic production are to use materials and practices that enhance the ecological balance of natural systems and that integrate the parts of the farming system into an ecological whole. Organic agriculture practices cannot ensure that products are completely free of residues; however, methods are used to minimize pollution from air, soil and water.

Herbicides and insecticides are mainly used in the pre-harvest stages, rodenticides are employed in the post-harvest storage stages, and fungicides are applied at any stage of the process depending on the crop. These chemicals can be transferred from plants to animals via the food chain. For example, more than 800 different kinds of pesticides are used for the control of insects, rodents, fungi and unwanted plants in the process of agricultural production. Although most of these are meant to degrade in soil, water and atmosphere before the food product reaches the consumer's table, trace amounts of these pesticide residues can be transferred to humans via the food chain, being potentially harmful to human health [1].

To limit the acceptable risk levels of pesticide residues, federal regulations on maximum residue limits (MRLs) for pesticide residues in foods have been established in many countries and health organizations, for example in the United States, Japan, European Union, and Food and Agriculture Organization (FAO). They are set for a wide range of food commodities of plant and animal origin, and they usually apply to the product as placed on the market. MRLs are not simply set as toxicological threshold levels, they are derived after a comprehensive assessment of the properties of the active substance and the residue behavior on treated crops. These legislative limits have become stricter than ever due to the concerns of food safety and the demands of trade barriers, driving the demand for more sensitive and reliable analysis methods for pesticide residues [2].

The analysis of these residues in foods currently requires both extensive sample preparation and expensive analytical instrumentation. Most pesticide residue detection methods for food samples comprise two key preparation steps prior to identification/quantification: extraction of target analytes from the bulk of the matrix, and partitioning of the residues in an immiscible solvent and/or clean-up of analytes from matrix co-extractives, especially fat which interferes with assays. Although there has been significant advancement in the sophistication and power of analytical instruments [3], the ultimate detection limits and quantification accuracy are still primarily influenced by interferences from food matrices [4] [5] [6] [7]. Thus, sample preparation is the bottleneck for the effective and accurate analysis of trace pesticide residues [4] [5].

The aim of sample preparation is to isolate the trace amounts of analytes from a large quantity of complex matrices and eliminate the interferences from the food matrix as much as possible. Typical sample preparation steps include the sampling/homogenization, extraction, and clean-up. Among them, the extraction and clean-up steps play a critical role in the success of pesticide residue analysis. The traditional sample extraction methods, especially liquid-liquid extraction (LLE), have been widely used for pesticide residue analysis.

However, most of these methods are time consuming and use large quantities of organic solvents to remove interference. Recent analytical developments have attempted to minimize the number of physical and chemical manipulations, the solvent volumes, the number of solvent evaporation steps, the use of toxic solvent, and have aimed to automate the extraction and clean-up procedures as far as possible. These include: supercritical-fluid extraction (SFE), pressurized-liquid extraction (PLE), microwave-assisted extraction (MAE), ultrasound-assisted extraction (UAE), gel permeation chromatography (GPC), solid-phase extraction (SPE), molecularly imprinted polymers (MIPs), matrix solid-phase dispersion (MSPD), solid-phase micro-extraction (SPME), QuEChERS, cloud point extraction (CPE) and liquid phase micro-extraction (LPME).

### Analysis of Naturally Occurring Molecular Components of Agricultural Products.

Another area of interest is the analysis of intrinsic molecular components in food products that are regulated for economic or health reasons. Examples include alcohol in beer, liquor or spirits, caffeine in coffee, nicotine in tobacco products and cannabinoids in marijuana-based products. Rather than address all of these products, we will consider, as an example, the regulation of cannabinoids in various products. Numerous methods for identifying cannabis constituents have appeared in the literature dating back to 1964 [8]. Some of these techniques were very simple, involving TLC on silica gel plates with visual detection by color reaction [9] [10] [11] [12] [13] [14]. The development of hyphenated chromatographic techniques has enabled positive identification of the major components of cannabis samples. These techniques include gas chromatography with mass spectrometry, diode-array ultraviolet absorption detectors (DAD) in conjunction with high-performance liquid chromatography (HPLC), and UV/Visible wavelength scanners in conjunction with thin-layer chromatography (TLC). These techniques allow identification of the three main neutral cannabis constituents (FIG. 1)—cannabidiol (CBD), Δ-9-tetrahydro-cannabinol (Δ9-THC) and cannabinol (CBN)— by comparison with published data in each area. HPLC using normal or reversed phases and detection by absorption at different wavelengths [15] [16] [17] [18] [19] [20] or electrochemical means [21], and more complex techniques combining capillary or packed-column GC with mass spectrometry [22] [23] [24] [25] [26].

Gas chromatography coupled with mass spectrometry (GCMS), seems to have emerged as the method of choice for analysis of cannabinoids in hemp food products [22] [23] [24] [25] [26]. The official method of the European Community for the quantitative determination of THC in hemp varieties [27] uses gas chromatography with a flame ionization detector. On the basis of THC content cannabis plants are divided into fiber-type and drug-type plants. The ratio (THC+CBN)/CBD has been proposed for distinguishing between the phenotypes of cannabis plants; if the ratio obtained is greater than 1, the cannabis plant is classified as drug-type; if it is less than 1, it is a fiber-type.

After the legalization of fiber-hemp cultivation in many parts of the world, hemp food products, mostly sold in esoteric stores, were eaten, because of supposed psychoactive properties associated with a potential THC content. Positive drug tests for marijuana use have been reported after ingestion of hempseed oil and other hemp foods. Since the mid 1990's, hemp food has gradually expanded into the natural product market and is increasingly found in natural food stores sold for nutritional and health benefits. A wide variety of hemp-based products is available, including hemp leaves (tea), hemp seed and seed derivatives, oil, flour, beverages (beer, lemonade), and cosmetic products. Hemp food products, even from fiber-type cannabis varieties, generally contain measurable amounts of THC. Previous analyses of hemp seed oil have revealed a wide range of THC concentrations between 11.5-117.5 mg kg⁻¹ and 7-150 mg kg⁻¹. For sample preparation all these methods use traditional liquid-liquid extraction (LLE), which is time-consuming and requires large volumes of solvents.

### Sample Preparation

For “dirty” samples, e.g., plant materials, GC used with vaporizing injection techniques is most suitable. “Classical” hot split-less injection of a solvent extract of the plant material is the most frequently applied injection technique, however, some adverse effects such as discrimination of low volatiles, sorption and thermal degradation can occur. Another alternative to classical hot split-less injection is programmable temperature vaporization (PTV). This injection technique, first introduced in 1979, comprises injection of the sample into the cold liner (temperature held below or near the solvent boiling point) and subsequent increase of temperature and transfer of analytes. This technique was shown to avoid discrimination of low volatile compounds and avoid degradation of thermally unstable analytes. The main advantage of PTV, however, includes the possibility of large volume injection (LVI). In the solvent split mode, the PTV allows one to introduce up to 1 ml of sample into the GC system. Injection of large sample volumes not only system. Injection of large sample volumes not only enables significant improvement of overall sensitivity of the analytical method, but also makes the PTV injector applicable for the on-line coupling of GC techniques with various clean-up and enrichment techniques. Otherwise, most analytical procedures require extensive extraction and concentration enhancement steps that make the analysis fairly complex.

Typical procedures used to extract neutral cannabinoids utilize solvent extraction of the plant material. The extracts are obtained by ultrasound mixing (for 15 minutes) of each of the samples, in the ratio of 100 mg of substance to 10 ml of solvent (a mixture consisting of 90 percent hexane and 10 percent chloroform), after which the extracts are ultra-centrifuged for 15 minutes at 10,000 revolutions per minute to isolate the clear supernatant. Solid-phase microextraction (SPME), discovered and developed by Pawliszyn and co-workers [28], has recently emerged as a versatile solvent-free alternative to these conventional liquid-liquid extraction procedures.

Headspace solid-phase microextraction (HS-SPME) is based on the distribution of analytes between the sample, the headspace above the sample, and a coated fused-silica fiber. Analytes are absorbed by the coating of the fiber, where they are focused, until the concentrations in the phases are in equilibrium. Subsequently, the fiber can be injected directly into a GC injection port for thermal desorption. Headspace extraction contrasts with extraction of the analytes by dipping the fiber into the aqueous phase (direct immersion, DISPME) and is advantageous because the low matrix interferences result in a diminished chromatographic background, solvent consumption is markedly reduced and its overall technical performance is fast and simple. The use of SPME in food analysis was recently reviewed by Kataoka [29].

A more complete approach for the analysis of all cannabinoids in plant samples uses heat to induce the decarboxylation of acidic components. Typically neutral cannabinoids are formed during storage of the plant material but, in order to obtain total cannabinoid in the neutral form, Smith [30] heated the plant material at 100° C. for 6 min under a nitrogen purge. Later investigations showed that stronger heating for prolonged times (i.e. 200° C. for 30 min) caused loss of neutral cannabinoids by evaporation even when the samples were treated in screw cap culture tubes under an atmosphere of nitrogen [31]. Heating plant material at 37 and 60° C. gave significantly different results for neutral cannabinoids [32].

Veress et al. [33] investigated decarboxylation of cannabinoid acids in an open reactor in a study which involved different solvents (n-hexane, ethylene glycol, diethylene glycol, n-octanol, dioctyl phthalate and dimethylsulphoxide), different temperatures and heating times, and various decarboxylation media, for example glass and various sorbent surfaces. The conclusion was that the optimum conditions for the decarboxylation of cannabinoid acids, in the presence or absence of organic solvent, always required temperatures at which the neutral cannabinoids evaporated. Consequently, it is not possible to bring about the conversion of cannabinoid acids into equivalent amounts of neutral cannabinoids by simply heating in an open reactor. It appears that the best conditions for the decarboxylation of cannabinoid acids in closed reactors (screw cap culture tubes) involve heating the samples at 200° C. for just 2 min [31].

### Sample Handling and Tracking

In many cases, it is difficult to track samples, especially when the sample material is not directly connected to a sub-sample, i.e., the sample extract. In many instances, sample tracking can be facilitated through the use of Automatic Identification and Data Capture (AIDC), a term frequently used to describe the identification of articles and collection of data into a processor controlled device without the use of a keyboard. AIDC technology is designed to increase efficiency in collection and identification by reducing errors and increasing the rate of identification and collection. For the purposes of automatic identification, a product item is commonly identified by a 12-digit Universal Product Code (UPC), encoded machine-readably in the form of a printed bar code. The most common UPC numbering system incorporates a 5-digit manufacturer number and a 5-digit item number. Because of its limited precision, a UPC is used to identify a class of product rather than an individual product item. The Uniform Code Council and EAN International define and administer the UPC and related codes as subsets of the 14-digit Global Trade Item Number (GTIN).

Within supply chain management, there is considerable interest in expanding or replacing the UPC scheme to allow individual product items to be uniquely identified and thereby tracked. Individual item tagging can reduce “shrinkage” due to lost, stolen or spoiled goods, improve the efficiency of demand-driven manufacturing and supply, facilitate the profiling of product usage, and improve the customer experience.

There are two main contenders for individual item tagging: visible two-dimensional bar codes, and radio frequency identification (RFID) tags. Bar code symbols and bar codes represent one type of AIDC technology. Bar codes have become ubiquitous parts of everyday commercial transactions. Merchandise carried by grocery stores, for example, is labeled with a barcode. A scanner is used to identify an item at the point of purchase by the consumer. The scanner uses the bar code information to look up the item's price. The price is then provided to a cash register for tallying the customer's bill.

Bar codes traditionally consist of a sequence of two element types: bars and spaces. The bars and spaces are arranged such that the bars are parallel and the spaces separate the bars. One encoding methodology varies the width and the sequence of the elements to encode alphanumeric data. The particular encoding methodology is referred to as a barcode symbology. An optical scanner is used to read the bar code symbol and decode the bar code to provide the original alphanumeric data.

The use of the data may vary depending upon the needs of the inquiring entity. A grocery store, for example, may need a unique identifier for a particular product in order to enable calculation of price at checkout or for managing inventory. A medical supplier, however, may need to identify manufacturing dates, lot numbers, expiration dates, and other information about the same product to enable better distribution control. The level of identification needed may vary depending upon the intended use.

Bar code symbologies are efficiently designed to support a specific industry need rather than a wide range of needs. A number of bar code symbologies are presently being used to track products throughout their life expectancy as they are manufactured, distributed, stored, sold, serviced, and disposed of. The bar code symbology designed for one application, however, may not suffice the needs of another application.

Bar codes have the advantage of being inexpensive, but require optical line-of-sight for reading and in some cases appropriate orientation of the bar code relative to the sensor. Additionally they often detract from the appearance of the product label or packaging. Finally, damage to even a relatively minor portion of the bar code can prevent successful detection and interpretation of the bar code.

RFID tags have the advantage of supporting omnidirectional reading, but are comparatively expensive. Additionally, the presence of metal or liquid can seriously interfere with RFID tag performance, undermining the omnidirectional reading advantage. Passive (reader-powered) RFID tags are projected to be priced at 10 cents each in multi-million quantities by the end of 2003, and at 5 cents each soon thereafter, but this still falls short of the sub-one-cent industry target for low-price items such as grocery. The read-only nature of most optical tags has been cited as a disadvantage, since status changes cannot be written to a tag as an item progresses through the supply chain. However, this disadvantage is mitigated by the fact that a read-only tag can refer to information maintained dynamically on a network.

A two-dimension barcode is a new technology of information storage and transmission, which is widely used in various applications, including product identification, security and anti-counterfeiting, and E-commerce. The two-dimension barcode records information data with specific geometric patterns of black and white graphic symbols arranged in two-dimensional directions. The concept of logical basis of “0” and “1” bit stream adopted in computer systems is utilized to form graphic symbols that correspond to binary representation of text and numerical information. The graphic symbols can be read by an image input device or a photoelectric scanning device to achieve automatic information processing.

International standards of the two-dimension barcode include for example PDF417, Data Matrix, Maxi Code, and QR (Quick Response) Code, among which QR code is most widely used. The QR code shows an advantage of high-speed and all-direction (360 degrees) accessibility, and is capable of representation of Chinese characters, rendering QR code wide applicability in various fields. The QR code comprises a square array of a series of small square message blocks, in which “0” or “1” are represented through variation of gray levels of bright and dark blocks.

### Chromatographic and Mass Spectrometric Analysis

GC is the most widely used technique in herbicide and cannabinoid analysis, but it cannot be used directly to analyze all cannabinoids owing to limitations in volatility of the compounds. Analysis of cannabis by GC has been reviewed [34]. Although the cannabinoids have very similar structural features, adequate separations of most of these compounds have been achieved on a number of commercially-available stationary phases. The most widely used are fused silica non-polar columns such as HP-1 and HP-5 as well as DB-1 and DB-5. Identification of the constituents is most readily performed by MS: un-derivatized 1, 3 and 6 show characteristic peaks at m/z values of 314, 246, 231, 193, 174 and 121, of 314, 299, 271, 231 and 55, and of 310, 296, 295 and 238, respectively [35].

Although GC analysis is suitable for plant cannabinoids, the method is restricted to the determination of the quality of cannabis for smoking if used directly since it can only provide information about the decarboxylated cannabinoids such as Δ9-THC [17]. Many GC reports concern non-derivatization methods because the target of most analysis is the main neutral cannabinoids, and also because it is very difficult to obtain a complete derivatization of a sample for the purposes of quantification. The carboxyl group is not very stable and is easily lost as CO2 under influence of heat or light, resulting in the corresponding neutral cannabinoids: THC, cannabidiol (CBD) and cannabigerol (CBG) [36]. These are formed during heating and drying of harvested plant material, or during storage and when cannabis is smoked [37] [38] [39].

The variable conditions during all stages of growing, harvesting, processing, storage and use also induce the presence of breakdown products of cannabinoids. The most commonly found degradation product in aged cannabis is cannabinol (CBN), produced by oxidative degradation of THC under the influence of heat and light [40]. In order to quantify the “total THC content” once present in the fresh plant material, the concentrations of degradation products have to be added to THCA and THC contents.

A number of compounds have been used successfully as internal standards for quantitative analysis. In particular, 5α-cholestane (Matsunaga et al., 1990), docosane (Ferioli et al., 2000) and tetracosane (Stefanidou et al., 2000) are commonly employed because of their suitability for use with a flame ionization detection (FID). A recent development involves the use of deuterated cannabinoids as internal standards when MS detection is employed. Hexadeuterated (d6)-Δ9-THC gives a better linearity of measurement than (d3)-Δ9-THC (Joern, 1992) and can also be used as a standard in HPLC because it has a different retention time than 3. Ross et al. (2000) employed (d9)-Δ9-THC as a reference compound in order to demonstrate that no cannabinoids are present in cannabis seeds even in the drug phenotype: the cannabinoids often found on the seed surface probably arise from contamination during harvesting.

### Electrochemical Techniques

Previous work has shown that it is possible to detect the phenol part of complex molecules by reaction with an electrochemically-generated reagent [41]. In this protocol, the loss of dichloro-benzoquinone monoamine can be monitored electrochemically as it reacts with the substituted phenol of choice. Known as the Gibbs reagent (FIG. 2), it has been used to detect substituted phenols spectrophotometrically, where it has been observed that the most easily displaced substitutes (good anionic-leaving groups) give rise to high yields of dichloroindophenol, while methylphenol and longer alkyl group substitutions such as hydroxybiphenyl, ethylphenol and hydroxybenzoic acid gave no detectable colored product [42]. It has been reported that phenol and phenoxyphenol give good yields of colored products (60 and 63%, respectively), methylphenol gives a low yield (18%), while nitrophenol produces a negative Gibbs reaction [42]. However, this technique is based on observing the product of the Gibbs (or related) reaction, not the consumption of the reagent.

A range of substituted phenols were investigated to determine the versatility of the indirect voltammetric method. This technique is based on the electrochemical oxidation of 2,6-dichloro-p-amino-phenol dissolved in aqueous solution which produces quinoneimine (QI) as shown in FIG. 3. On addition of Δ9-THC the reduction wave, corresponding to the electrochemical reduction of quinoneimine (QI) back to aminophenol (AP), as shown in FIG. 3, reduces in magnitude since the QI chemically reacts with Δ9-THC providing a useful analytical signal. This methodology is extremely attractive since it avoids the direct oxidation of Δ9-THC which can lead to electrode passivation [43]. In similar work, graphite powder was modified with 4-amino-2,6-diphenylphenol which was abrasively immobilized onto a basal plane pyrolytic graphite electrode and assessed for the indirect electrochemical sensing of Δ9-THC in saliva [44]. In this way the detection technique based on the electrochemical formation of the QI was entirely surface confined in respect of the specific agent detecting the cannabis related material.

### Immunoassay Techniques

Immunoassays seem promising for studying cannabinoid metabolites because they are very sensitive, they are able to identify a small class of closely related compounds, and they can be applied directly to the sample without prior extraction or purification. The major problem with immunoassays is, however, one of selectivity. These methods need high-affinity, specific antibodies, but obtaining a very specific antibody that will only bind to one specific antigen is not an easy task since most antibodies bind to a group of closely related compounds. Thus, while immunoassays are particularly suited for screening purposes, positive immunoassay tests should be followed by further confirmative analysis to exclude false positive results [45] [46]. Indeed, according to recent European Union recommendations on testing for drug abuse, and to the USA Mandatory Guidelines for Federal Workplace Drug Testing Programs, chromatographic techniques should always be used to confirm the results obtained by screening with immunoassays [46].

Four main immunoassay techniques are used in screening for cannabinoids, namely, radioimmunoassay (RIA), fluorescence polarization immunoassay (FPIA), enzyme multiplied immunoassay technique (EMIT), and enzyme-linked immunosorbent assay (ELISA). All of these methods are based on the competitive binding of a labeled antigen and unlabeled antigens from the sample with a limited, known amount of an antibody in the reaction mixture. The RIA and FPIA strategies are very similar in that both determine unbound antigen by either radioactive or fluorescent measurement. In RIA, the bound antigen should be separated from the unbound antigen before radioactivity measurement and, for this purpose, a second antibody is required. The principle of FPIA is that the fluorophore on the free antigen will emit light at a different plane compared with that on the bound antigen.

The measurement of the retention of polarization may be performed without physically separating the bound and the unbound antigens [47]. EMIT is based on the absorbance change produced by the reduction of NAD to NADH coupled to the oxidation of glucose-6-phosphate to 6-phosphogluconolactone, a reaction catalyzed by the enzyme glucose-6-phosphate dehydrogenase attached to the free antigen. The concentration of analyte in the sample determines the amount of free antigen that is labeled with the enzyme, and this is indirectly determines the change in absorbance that is measured [47]. Currently there is only one report of the analysis of plant cannabinoids by immunoassay [48] in which Δ9-THC was measured in a methanolic leaf extract by FPIA using a highly selective monoclonal antibody. The result was confirmed by GC and the immunoassay showed good linear correlation (r=0.977) with the chromatographic method.

### Drawbacks and Limitations of Previous Approaches

While tremendous advances have been made in many aspects of the process of sampling volatile components of many samples, the analytical process is still largely time-consuming and expensive, requiring sophisticated technology and highly trained individuals to perform the analysis. There is a great need for simpler and less expensive processes to make such analyses available to a wider audience, who have less technical experience and smaller budgets available for analytical work. Examples of situations where such analytical work would really benefit the customer include groceries and food stores, where staff and customers could ascertain the “organic” quality of grains, produce and meats through a rapid analysis of the content of pesticides, herbicide and other potential contaminants of the commodities that they are buying; the growers and distributers of such commodities, such that they could guarantee the “organic” quality of their products; microbreweries and home brewers, who wish to ascertain the quality of the grains, rice and other commodities used in brewing beer; tobacco farmers and distributors, who wish to determine the nicotine content of tobacco leaves and other products during harvest and distribution; medical marijuana growers, dispensaries, regulators and customers, who wish to ascertain the THC content of hemp and marijuana leaves and other products during harvest and distribution, so as to ascertain the value of their commodities and certify the potency of their products. Therefore, there is a great need for a new technology that separates the sampling process from the analysis process, so as to make the overall analysis more widely available to a larger, less technical market.

### BRIEF SUMMARY OF THE INVENTION

The disclosed embodiments relate generally to the chemical analysis of food and agricultural products. More particularly, the disclosed embodiments relate to instrumentation used in the collection of chemical samples from food and agricultural products, the chemical analysis of those samples and the disposition of the data collected in the analysis of those samples.

### BRIEF DESCRIPTION OF THE DRAWINGS

FIG. 1—Structures of common cannabinoid molecules.

FIG. 2—Mechanism of reaction of aminophenols in the Gibbs Reaction.

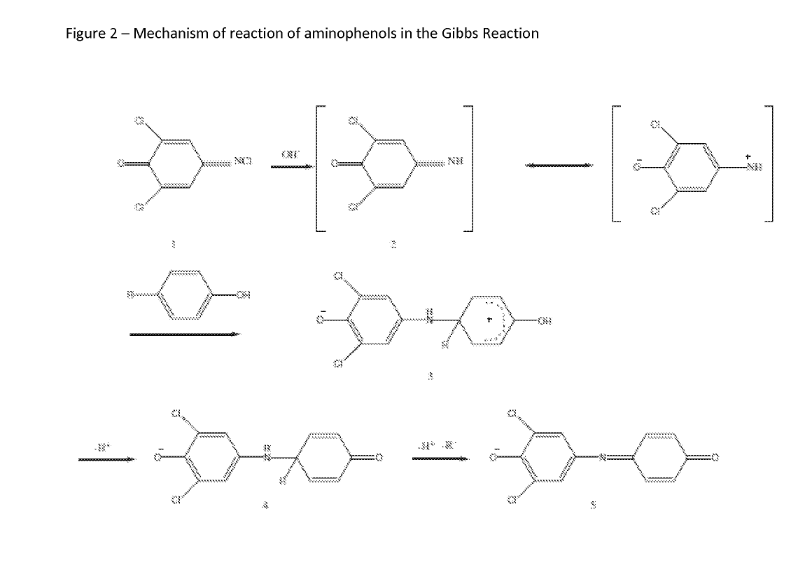

FIG. 3—The electrochemical oxidation of aminophenol.

FIG. 4—Cyclic voltammetry of 2,4 dichloro-p-aminophenol (PAP) in pH 10 borate buffer at 100 mV/s at a polished glassy carbon electrode;

FIG. 5—The Square Wave voltammetric response to PAP at a polished glassy carbon electrode before (A) and after addition of 200 uM (B) and 400 uM (C) concentrations of p-phenylyphenol, where the signal is found to decrease with added phenol concentrations. The square wave parameters are: 4 s at +0.4V followed by a potential sweep from +O.4 V to −O.4 V;

FIG. 6—The SW voltammetric response to PAP at a carbon paste electrode in pH 10 borate buffer before (A) and after addition of 200 uM (B), 400 uM (C) and 600 uM (D) concentrations of p-phenylyphenol, where the signal is found to decrease with added p-phenyphenol concentrations. The square wave parameters are: 4 s at +0.4V followed by a potential sweep from +O.4 V to −O.4 V;

FIG. 7 is a graph of the peak height versus added phenol concentration for square wave voltammograms of FIG. 6.

FIG. 8 show a schematic view of a sampling instrument comprising an apparatus for releasing volatile elements of a substance comprising in combination a power supply with an electronic controller in electrical communication with a heater and a pump, a thermocouple for sensing temperature, an user interface and external interface in electrical communication with the power supply, the electronic controller consisting in part, of a time and temperature control means that adjusts the heat produced by the heater and length of time heat is produced, information output means in electrical communication with the power supply that displays the temperature and time, a sample material holder which is insertable and removable for holding the substance connected via inert tubing to a target substrate holder which is insertable and removable for holding the target substrate. The time and temperature control means produces a variable heat according to the specific substance being volatized in the apparatus. In one configuration, a sampling device in which a syringe pump pushes a sample gas from the heated sample chamber through a tube across a target substrate; once sampling is completed, the valve between the pump and the target chamber is closed and the syringe pump is refilled through an outlet.

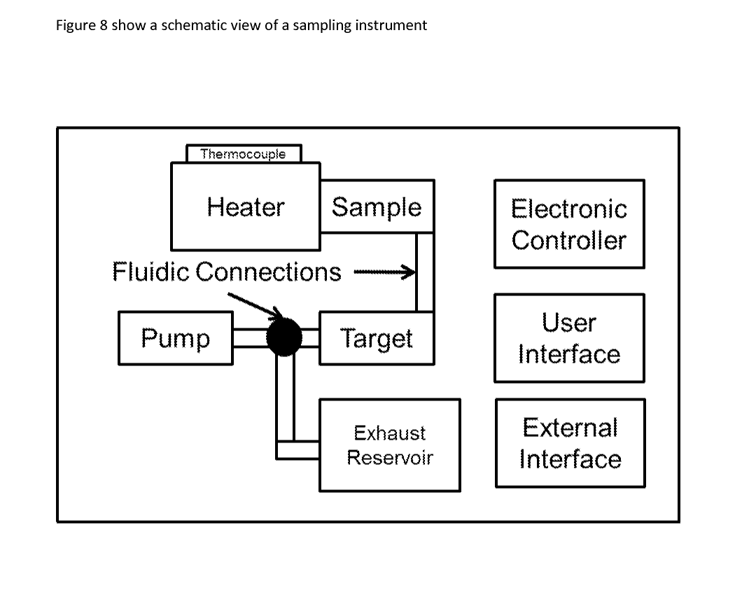

FIG. 9 shows a sampling device in which a pump pushes a sample gas from the heated sample chamber through a tube across a target substrate; once sampling is completed, the valve between the pump and the target chamber is closed and the pump is refilled through an outlet. After the sample is drawn across the target substrate, the target substrate is removed from the target chamber and placed in contact with an electrochemical sensor. The electrochemical sensor and target substrate are placed in contact and a small volume of electrolyte provides sufficient conductivity and solubility of the target analytes, so as to allow measurement the composition of selected chemical species within the target substrate.

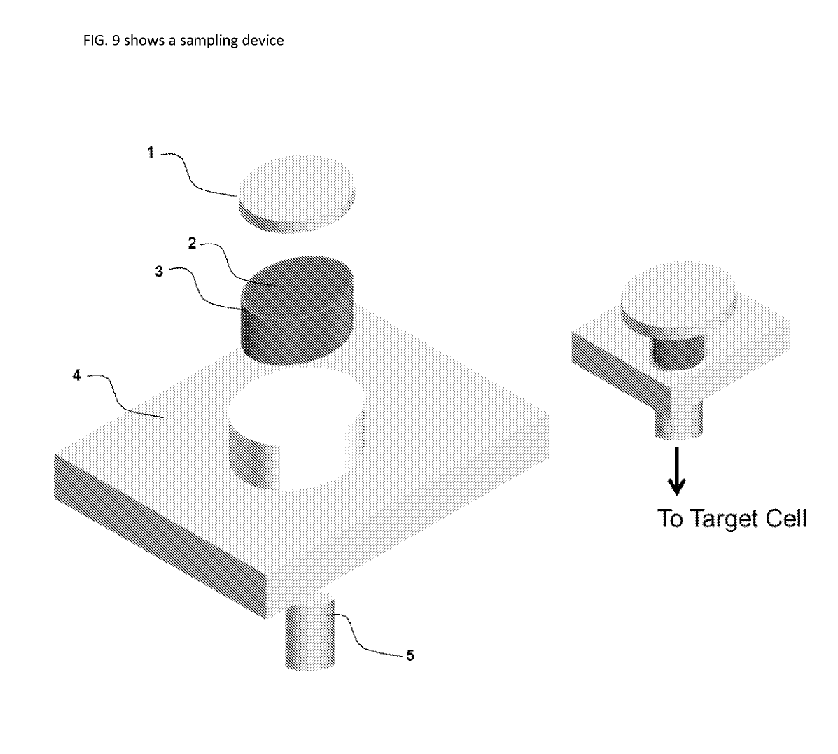

FIG. 10 shows a target holder comprised of input (3) and output (5) sections, where the input section is connected to a sampling device via a hole (4) and a tubular connector (5) and the output device is connected to a pump via another hole (6) and additional tubular connector (7). The input and output sections surround a target substrate (1), onto which is deposited the volatilized components of the heated sample (2). This can be accomplished by pushing a sample gas from the heated sample chamber through target holder across a target substrate. The target substrate material is composed of a solid support and/or adsorption matrix, configured to enhance the adsorption of selected sample vapors.

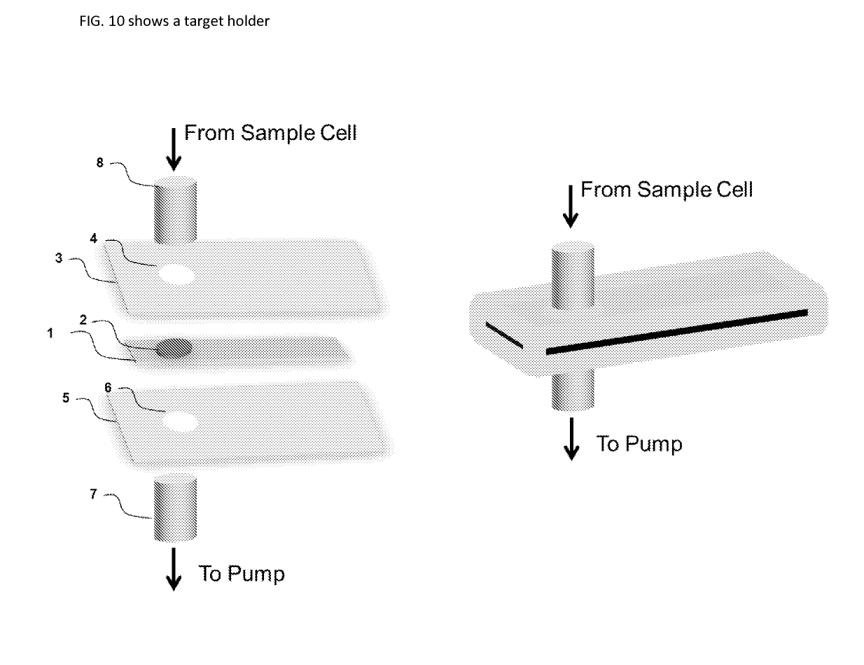

FIG. 11 shows a possible configuration of an electrochemical sensor designed for use with a vapor-deposited target. After the sample vapors are drawn across the target substrate (2) and the sample vapors are deposited on such substrate (1), the target substrate (2) is removed from the target chamber and placed in contact with a reagent strip (4) containing essential reagents (3) deposited within and an electrochemical sensor (5) containing electrodes (6) and connections (7). The electrochemical sensor, reagent strip and target substrate are placed in contact and a small volume of electrolyte provides sufficient conductivity and solubility of the reagents and target analytes, so as to allow electrochemical measurement the composition of selected chemical species within the target substrate via the separate sensor substrate.

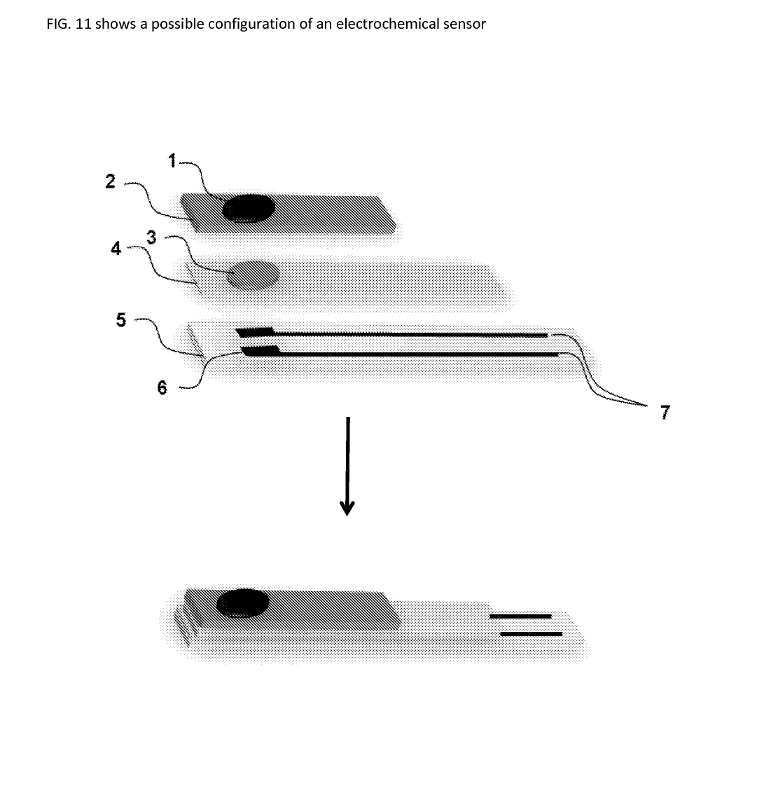

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

### SUMMARY OF THE INVENTION

It is to be understood that both the foregoing general description and the following description are exemplary and explanatory only and are not restrictive of the methods and devices described herein. In this application, the use of the singular includes the plural unless specifically state otherwise. Also, the use of “or” means “and/or” unless state otherwise. Similarly, “comprise,” “comprises,” “comprising,” “include,” “includes,” “including,” “has,” “have,” and “having” are not intended to be limiting.

Broadly stated, embodiments of the present invention provide analytical methods, instruments, and devices that address the shortcomings addressed above. The present invention provides a device, system, and associated methods that will actively or passively sample a material (solid, liquid or gas) by heating the sample, volatilizing it into the gas phase and directing it onto the surface of a substrate. The substrate is composed of a material (either a solid, or a liquid-coated solid) that has both high surface area and an active surface with excellent adsorptive properties. These properties can be tailored for retention of specific components or provide for broad adsorption of materials with general chemical properties. Accordingly, the invention provides methods for sampling and analysis of samples to determine the chemical compounds thereof at low concentrations. The invention also describes instrumentation for the chemical analysis of materials adsorbed onto this substrate, whether that analysis is directly coupled to the sampling step, or removed in distance and in time from the sampling event. A sample tracking interface is provided using a method for reading sample identification information present in a first region of the encoded physical medium and then correlating the measured information with the sample identification information has been encoded therein. According to one embodiment, the information may be encoded according to a spatial encoding scheme, a bar code scheme, or a combination thereof.

In one embodiment, the invention provides a method for detecting an analyte contained in a solid comprising the steps of heating the solid, directing a gas evolved from such heated solid comprising single or multiple chemical analyte(s) onto the surface of an adsorptive substrate (particularly a “target substrate,” as defined herein) in a sealed gas fluidic system for a period of time sufficient for the analyte to be adsorbed onto the surface; and then analyzing the analyte. The analyte can be analyzed directly, for example, by contacting said target substrate with a sensor, and quantitatively and/or qualitatively evaluating the chemical composition of the analyte(s) on said substrate by the response of the sensor.

In another embodiment, the target substrate thus obtained can be removed from the sampling instrument and placed in a suitable container that preserves the composition of the analyte within the target substrate, then shipped to a laboratory that contains appropriate instrumentation for chemical analysis. Once there, the analyte(s) contained within the target substrate can be analyzed with conventional analytical instrumentation commonly used for chemical separations (including gas chromatography (GC), high performance liquid chromatography (HPLC), thin layer chromatography (TLC) or any of a variety of other methods used for chemical separations) and these methods can be coupled with appropriate detection methods (such as flame ionization detection, mass spectrometry, UV or visible light absorbance, infrared or neat infrared absorbance spectroscopy, or other related methods). Such analysis can be done directly (for example, by placing the target substrate in the appropriate analytical instrument and performing the analysis) or after extraction, where the target substrate is placed in a minimum volume of an appropriate solvent, and the analyte(s) are solubilized in the solvent. The resulting solution can then be used as the sample matrix for chemical analysis (for example, the solution can be injected into a GC-MS or an HPLC-UV absorbance detector).

In one aspect of the present invention, an apparatus for creating volatile components of a substance is disclosed. The apparatus comprises in combination a power source, a heater, a pump sufficient to create a gas flow, a temperature sensor, time and temperature control, a source material holder for holding the sample substance which is connected via inert tubing to a second receptacle for holding a target substrate that receives the vapor that results from the release of volatile components created by heating the sample and releasing volatile elements in a sealed gas fluidic system. The pump may create positive pressure at the sample source sufficient to push the evolved gas through the target substrate, or it may be a vacuum pump that creates a negative pressure at the target substrate, such that the evolved gas is “sucked” from the sample chamber thru the target substrate without releasing the gas to ambient atmosphere. The temperature sensor may be a thermocouple or resistance temperature detector (RTD) or other device suitable for monitoring temperature. The heater may be a Ceramic UF Heater, simply resistive heating tape wrapped around the sample container, or other suitable heating device. The airflow may be between 0.1 and 100 mL/min. The apparatus is not meant to release volatile elements into the ambient air without prior removal of volatile components generated during heating. Also, the time and temperature controllers may produce a variable heat according to the specific substance being volatized in said apparatus.

The apparatus may further comprise an information input/output device in communication with the power supply that displays the relevant parameters and allows for adjustment of said parameters by controlling relevant components within the apparatus. It should be understood that the information input/output device may be in communication in a multitude of ways including wireless and fiber optic communication. Information may be manually inputted or programmed to be controlled automatically by the equipment into the information input/output device which in turn electrically communicates with the power, heater and pumps to adjust the temperature, flow rate and duration of the sampling process within said apparatus for a specified time. The time elapsed, temperature, and other desired information may be displayed on a display such as an LCD display. Also, an information retrieval and delivery means in electrical, optical or wireless communication with said device may be used. This may be a USB, firewire, Ethernet, wireless Ethernet, ilink interface, NV interface, telephone cable interface, parallel interface, fiber optics, serial interface or other communication method connected to the apparatus and an information source (e.g. computer). The information retrieval and delivery means may be a disk contained within the apparatus, or it may be transmitted via the aforementioned communication protocols to an external information source. The temperature provided by the heater means is preferably between 0° C. and 300° C.

The present invention improves the sample tracking interface by providing a method for interfacing via an encoded physical medium having a region wherein information has been encoded. The interface method includes reading sample identification information present in a first region of the encoded physical medium and then correlating the measured information with the sample identification information has been encoded therein. According to one embodiment, the information may be encoded according to a spatial encoding scheme, a bar code scheme, or a combination thereof. The present invention also teaches that when it is determined that the marker is present in the first region, the certain encoded information is translated into certain decoded information including a function to be performed by the computer system. The function to be performed by the computer system may include, among other things, providing a link to a webpage containing sample analysis information. The certain decoded information could also include a uniform resource locator (URL) and the function may involve the computer system accessing and/or displaying an Internet web page to which the URL directs.

The present invention further improves upon the sample tracking interface by teaching a method for generating an encoded physical medium having a region with encoded content. The method requires receiving content that is to be encoded into a desired location on the encoded physical medium, encoding the content according to a particular encoding scheme suitable for application onto the encoded physical medium, and inserting the encoded content together with a marker into a corresponding desired location within a representation of the encoded physical medium. The marker indicates that the content is encoded within the corresponding desired location, thereby enabling a subsequently engaged sensor to determine the existence of the content. Once the representation is created, the present invention further teaches that the encoded physical medium may be generated from the representation.

The present invention further teaches maintaining a database tracking the results of the user engaging the sensor with a plurality of samples, including the determination of multiple chemical components within a given sample. The database could then be used later to determine whether a specific condition (i.e., cannabinoid content exists within a given range) has been satisfied. In turn, a specified action could be specified by the computer system (i.e., satisfy quality control release criteria).

One separate embodiment of the present invention teaches a computer interface between the sample, a user and a computer system using an encoded physical medium. The encoded physical medium is suitable for having at least one region wherein information has been encoded. The computer interface includes a sensor operable for measuring information present on the encoded physical medium, and a first device coupled to the sensor and responsive to determine whether information measured by the sensor includes a marker indicating that certain encoded information is present in the measured information. In a related embodiment, the computer interface includes a second device responsive to the first device such that when the first device determines the presence of the specified content, the second device is operable to decode the certain encoded information present in the measured information. In yet another related embodiment, the computer interface also has a transmitter device operable to transmit the certain decoded information to the computer system.

According to another embodiment, an apparatus for releasing volatile elements of a substance in a sealed gas fluidic system is disclosed comprising in combination a power source in electrical communication with a heater and a pump, a thermocouple for sensing temperature, an information retrieval and delivery means in electrical communication with the power source, a time and temperature control device that adjusts the heat produced by the heater means and length of time heat is produced, information output means in electrical communication with the power means that displays the temperature and time, a source material holder for holding the substance connected via inert tubing to a target substrate holder for holding the target substrate. The time and temperature control means produces a variable heat according to the specific substance being volatized in a sealed gas fluidic system in the apparatus. The heat provided by the heater means is preferably between 0° C. and 300° C. and the gas flow between 0.1 and 100 mL/min. The heater can be energized at a defined rate, so as to create a programmed thermal cycle. This programmed thermal cycle allows the gradual heating of the sample, so that analytes with lower boiling points are volatilized first and removed from the sample before the heater produces temperatures that could decompose those materials. The heating is continued to volatilize additional higher boiling components and all those analytes are swept to the target substrate in a sealed gas fluidic system and adsorbed. In this way, a range of analytes of different boiling points can be effectively transferred to the target substrate without inducing thermal decomposition of the lower boiling materials.

The composition of the target substrate can be varied to alter the selectivity of the adsorption process. The selectivity of adsorption is determined by the chemical composition of the target substrate material, and as a general rule, the doctrine, “like dissolves like,” is applied. For example, if the target analyte is composed of hydrophobic material, then a hydrophobic target material is selected, since it is likely to adsorb the analyte more strongly. Similarly, if the analyte is hydrophilic, then a hydrophilic target material is selected. If the sample contains a variety of different chemicals with different solubilities, then the target substrate can comprise a combination of materials to adsorb the analytes.

Alternatively, the chemical composition of the target substrate can be altered by adding a thin film, or stationary phase to the surface of the substrate. As conventionally used in many chromatographic techniques, the stationary phase can consist of almost any material that can be deposited as a thin film and that forms a stable layer. Examples of non-polar stationary phases include HP-1, HP-5 as well as DB-1 and DB-5, while other examples of stationary phases include hydrophilic or hygroscopic materials, e.g. based on cellulose, modified cellulose such as cellulose nitrate or cellulose acetate, hydroxyalkylated cellulose, or modified and unmodified cellulose crosslinked with substances such as epichlorhydrin. Also suitable are glass fiber matrices and matrices consisting of polyester. These materials can either be used solely or in combination with other compound materials with a hydrophilic portion in the carrier matrix prevailing.

In a preferred manner, the target substrate materials are structured so as to form particles (e.g. pearl-like, see DD-A296 005) or fibers, such as filter papers on cellulose basis (EP-A 374684, EP-A 0470565). Other materials used for the construction of the target substrate are described in EP-A 0 374 684, EP-A 0 353 570 and EP-A 353 501. The first carrier matrix must be gas-permeable to allow suitable animals with the corresponding immunogen. The enrichment of the immunologically active substance from the gas phase. For pressure gradients above the adsorber (200-500 mbar) which are technically easy to implement, the gas permeabilities advantageously range between 1 mL/min and 100 L/min, preferably between 10 mL/min and 100 mL/min.

In another embodiment, the target substrate's chemical composition can be altered through reaction with specific binding components. Biosensors making use of the principle of an immunological reaction between the analyte and binding partners contained in the biosensor would be potentially suitable for such tasks due to the high selectivity and specificity of the immunological reactions. A biosensor of this kind has been described by Ngen-Ngwainbi [49]. In this reference, an antibody to a cocaine metabolite (benzoylecgonine) as a reactive component of the sensor is used as a Piezo transducer with a resonance frequency of 9 MHz. The antibody is immobilized through physical adsorption on the surface of the sensor. The lower detection limit is at 0.5 ppb corresponding to 2×10⁻¹¹ mol/L in gas phase (for cocaine and cocaine-HCl).

The invention also includes devices and instruments for use in the methods of the invention. For example, the invention includes a device for active sampling of a gas and directing the same gas onto a target substrate comprising a gas conduit having a sample port and a sealed gas fluidic system; the sample port is fluidly connected to a target holder containing a target substrate, wherein the sample port is capable of directing a gas from the sample chamber onto a target substrate; and a pump for introducing the gas through the sample port and moving the gas through the target holder such that the analyte can adsorb onto the target substrate in a sealed gas fluidic system.

In another embodiment, the chemical composition of the analyte adsorbed onto the test substrate is determined by placing the test substrate in contact with an electrochemical sensor capable of sensing the desired analyte. The electrochemical sensor can monitor the presence of the phenolic molecule by direct oxidation of the phenol, for example, as shown for the electrochemical oxidation of phenol on a metal oxide electrode [50]. Alternatively, the electrochemical sensor can consist of a carbon electrode modified with reagents that emulate the Gibbs reaction. The present invention modifies or builds on the known Gibbs reaction by electrochemically oxidizing a p-aminophenol (PAP) to form a benzoquinone monoamine (for example, a dichloro- or diphenyl-benzoquinone monoamine), which then reacts with the substituted phenol compound of interest, as in the classical Gibbs reaction. Monitoring the reduction of an oxidized PAP provides an indirect method of detecting phenols and phenolic compounds, or example phenol, 4-phenoxyphenol, methylphenol (para and meta), nitrophenol, cannabinoids (e.g. tetrahydrocannabinol) and catechins (e.g. EGCG or ECG). The methodology according to the present invention is attractive since it avoids the direct oxidation of the phenol, which can lead to electrode passivation. The PAP may be present in the electrolyte and/or on the surface or in the bulk of the working electrode material.

In one embodiment of the invention there is provided an electrochemical sensor for the detection of a phenol-containing molecule, which comprises a first compound, a working electrode and an electrolyte in contact with the working electrode, wherein the first compound operatively undergoes a redox reaction at the working electrode to form a second compound which operatively reacts in situ with the phenol, wherein said redox reaction has a detectable redox couple and wherein the sensor is adapted to determine the electrochemical response of the working electrode to the consumption of said second compound on reaction with the phenol.

In another embodiment of the invention there is provided a method of sensing a phenol-containing molecule in a sample, comprising: (a) oxidizing a first compound at the working electrode of an electrochemical sensor to form a second compound which is operatively reactive with the phenol-containing molecule; (b) contacting the phenol-containing molecule with the second compound in the presence of an electrolyte, such that the second compound reacts with the phenol-containing molecule; and (c) determining the electrochemical response of the working electrode to the consumption of the second compound on reaction with the phenol-containing molecule.

In the present invention, phenol-containing molecules can be detected indirectly. A number of electrochemical biosensors have been developed for the monitoring of phenols in aqueous systems. Laccase, catechol oxidase, and tyrosinase have been used as biosensitive part of sensors in combination with other modifiers like carbon nanotubes (CNT), magnetic core-shell (Fe₃O₄—SiO₂) nanoparticles, and polypyrrole. This approach leads to improvement of determination analytical selectivity and sensitivity [50].

In particular, the present invention involves the use of a compound which operatively undergoes a redox reaction at the working electrode, wherein the reaction has a detectable redox couple and wherein the product of said reaction operatively reacts in situ with the phenol-containing molecule. The electro-chemical response of the working electrode to the consumption of the said compound on reaction with the phenol-containing molecule is then determined. The phenol-containing molecule may be contacted with the compound prior to, contemporaneously with or subsequent to the oxidation of the compound, but is typically admitted subsequent thereto.

In another embodiment of the invention, the choice of suitable sensor arrangement and materials is important when considering the moiety to be sensed, temperature range and electrochemical method to be used. Amperometric sensors have been found to enable low cost of components, small size, and lower power consumption than other types of sensor, and are ideal for use in portable analysis systems. In the present invention, amperometric sensing methodology is typically employed.

The working electrode may be a screen printed electrode, a metallic electrode, a metal nitride, a semiconductor, an edge plane pyrolytic graphite electrode, a basal plane pyrolytic graphite electrode, a gold electrode, a glassy carbon electrode, a boron doped diamond electrode, or a highly ordered pyrolytic graphite electrode. The working electrode may be a microelectrode or a macroelectrode.

Determination of the electrochemical response of the working electrode may comprise measuring the current flow between the working electrode and a counter electrode to determine the amount of phenol or phenolic compound. It is particularly preferred that the working electrode is operatively maintained at a constant voltage. In one embodiment, the current is measured using linear sweep or cyclic voltammetry. In another embodiment, said current is measured using square wave voltammetry. In an alternative embodiment, the current is measured using a pulsed voltammetry technique, in particular differential pulse voltammetry.

### THE FOLLOWING EXAMPLES ILLUSTRATE THE INVENTION

### Example 1

### Sampling Procedures to Determined Cannabinoids in Hemp Products for by Means of GC-MS

Sample preparation, extraction and gas chromatographic separation conditions were derived from a literature reference [51]. These are summarized below:

### Reagents and Materials

Cannabidiol (CBD), cannabinol (CBN), Δ9-tetrahydrocannabinol (THC), and Δ9-tetrahydrocannabinol-d3 (THC-d3) were purchased from Promochem (Wesel, Germany). N-methyl-N-trimethylsilyltrifluoroacetamide (MSTFA) was obtained from Macherey-Nagel (Düren, Germany). A SPME device for an autosampler with a replaceable 100-μm polydimethylsiloxane (PDMS) fiber was obtained from Supelco (Deisenhofen, Germany). The SPME fiber was conditioned at 250° C. for one hour in the injection port of the gas chromatograph, according to the supplier's instructions. Chemicals were purchased from Merck (Darmstadt, Germany).

### GC-MS Method

GC-MS analyses were carried out on a HP 6890 Series Plus gas chromatograph coupled to a 5973N mass-selective detector (Agilent) and an autosampler. Data acquisition and analysis were performed using standard software supplied by the manufacturer (Agilent Chemstation). Substances were separated on a fused silica capillary column (HP-5MS, 30 m×0.25 mm i.d., film thickness 0.25 μm). Temperature program: 160° C. hold for 1 min, 15° min⁻¹ to 190° C., hold for 1 min, 5° min⁻¹ to 250° C., hold for 1 min, 20° min⁻¹ to 300° C., hold for 2 min. The injection port, ion source, quadrupole, and interface temperatures were 250° C., 230° C., 150° C. and 280° C., respectively. Splitless injection mode was used and helium, with a flow rate of 1.0 mL min⁻¹, was used as carrier gas.

### Samples and Sample Preparation

A diverse range of commercially available hemp food products were purchased from esoteric and nature stores and via the internet. All solid samples were blended and homogenized in a standard mixer. Liquid samples were homogenized by shaking. Hemp tea infusions were prepared by pouring 100 mL boiling water on 1.5 g tea. After 15 min, the infusion was filtered.

### SPME Extraction

For HS-SPME extraction, approximately 50 mg (tea), 400 mg (chocolate, snack bar, thin slices), 100 mg (seed, flour, fruit bar, nibbles), 1000 mg (pastilles), 100 μL (oil), 500 μL (lemonade, beer), or 1000 μL (tea infusion, shampoo) sample were placed directly in a 10-mL headspace vial in the presence of 1 mL NaOH (1 mol L⁻¹), 0.5 g of sodium carbonate, and 100 μL aqueous internal standard solution (200 ng mL⁻¹ THC-d3). For on-coating derivatization, a separate vial containing 25 μL derivatization reagents (MSTFA for silylation) was prepared for each sample. The vials were sealed using a silicone/PTFA septum and a magnetic cap. The sample vial was shaken for 5 min at 90° C. in the agitator of the autosampler (650 rpm, agitator on time 0:05 min, agitator off time 0:02 min). For absorption, the needle of the SPME device containing the extraction fiber was inserted through the septum of the vial and the fiber was exposed to the headspace in the vial for 25 min. Then for derivatization the fiber was exposed for 8 min at 90° C. in a second vial containing 25 μL MSTFA. Finally, the SPME fiber with the absorbed and derivatized compounds was introduced into the injection port of the GC-MS for 5 min to accomplish complete desorption of the analytes.

### Liquid-Liquid Extraction

For liquid-liquid extraction, 100 μL of the internal standard solution and 5 mL 9:1 (v/v) n-hexane-ethyl acetate were added to the same amount of sample; the mixture was homogenized for 15 min under ultrasonication and centrifuged for 5 min. The organic layer was separated and the lower layer was extracted another two times with 5 mL n-hexane-ethyl acetate. Alternatively, the oil samples were extracted three times with methanol. The combined organic extract was evaporated under nitrogen. The dried samples were derivatized with a mixture of 50 μL MSTFA, 20 μL pyridine, and 130 μL isooctane under incubation at 90° C. for 15 min. After transfer to GC injection vials 1 μL was injected for GC-MS analysis.

### Validation Studies

To examine the effect of the matrix on the SPME extraction process, multiple portions from 25 to 200 mg of hemp tea, hemp chocolate, and hemp oil were analyzed. For validation of the method, spiked samples were prepared, using olive oil, milk chocolate, and green tea as blank matrices. Precision and accuracy was determined by repeated analysis of the spiked samples. The linearity of the calibration plots was evaluated between 0.1 and 4 mg kg⁻¹ (related to 100 mg weighed portion). For determination of the limits of detection (LOD) and quantitation (LOQ), separate calibration curves in the range of the LOD (0.005-0.5 mg kg⁻¹) were established.

Comparison of HS-SPME with Conventional LLE

For purposes of comparison all samples were analyzed using HS-SPME and LLE, and comparison of representative chromatograms from GC-MS analysis of identical hemp tea samples using LLE and HS-SPME reveals the superiority of HS-SPME. In the LLE chromatogram several large matrix peaks elute in the retention-time range of the analytes, whereas when HS-SPME was used distinct peaks were acquired for all compounds with slight or little matrix interference.

This is in good agreement between levels of cannabinoids determined in food samples by HS-SPME and LLE [52]. The linearity of the correlation between HS-SPME and LLE was significant, with correlation coefficients of 0.992 (THC), 0.974 (CBD), and 0.985 (CBN). The slope and intercept of the regression lines show there is no constant or proportional difference between the two procedures. The limits of detection achieved by HS-SPME were comparable with those of already published methods applying conventional techniques; some were even better [52].

### GC Results

Lachenmeier et. al. reported that when thirty authentic samples were analyzed by means of HSSPME with GC-MS, no matrix interferences were observed. Headspace extraction in combination with SPME separates the semi-volatile cannabinoids from non-volatile compounds. Peak purity and selectivity are ensured. Interfering peaks, often observed in GC-MS analyses for THC after conventional extraction and silylation, are excluded, because of lower matrix contamination [52].

Recoveries of the analytes, as determined by both HS-SPME and LLE, depend on their distribution coefficients in the equilibrium of the extraction process for both procedures [52]. LLE involves homogenization of the two liquid phases to accelerate adjustment of the equilibrium concentrations. However, it is not possible to homogenize the phases in HS-SPME (since it is a two phase system), therefore the transfer of the molecules from the liquid to the gas phase is rate determining. Matrix properties such as viscosity or lipophilicity therefore affect the headspace procedure to a large extent, so the speed of diffusion of the analytes in the matrix is crucial. Extraction recoveries for simpler matrices (e.g. tea) were found to be proportional to the amount of sample.

Complex lipid- and protein-containing matrices, for example chocolate, caused significant matrix retention and lower recoveries [52]. Suppression of HS-SPME extraction recovery by lipid material has previously been reported, and the only way this could be mitigated was through the use of alkaline hydrolysis to saponify the lipids. They found that this resulted in low extraction yields, but it was possible to determine the cannabinoids reproducibly and automatically by using a versatile and programmable autosampler. Although the matrix varies considerably for the foods studied, the sensitivity of the procedure was sufficient to determine whether the THC content of the foods was within the guidance values.

### Example 2

### Electrochemical Materials and Methods

Sample preparation, extraction and gas chromatographic separation conditions were derived from a literature reference [41]. These are summarized below:

### Chemical and Materials:

All chemicals were of analytical grade and used as received without any further purification. These were Δ9-tetrahydrocannabinol (HPLC grade, >90%, ethanol solution), 2,6-dichloro-p-aminophenol, phenol, and 4-phenylphenol, (>98%, Sigma-Aldrich).

Solutions were prepared with deionized water of resistivity not less than 18.2 MOhm cm⁻¹ (Millipore Water Systems). Voltammetric measurements were carried out using a CH-650A potentiostat (CH Instruments, Austin, Tex.) with a three electrode configuration. Glassy carbon electrodes (CH Instruments, Austin, Tex.) or carbon paste electrodes were used as working electrodes. Carbon paste was prepared from a mixture of 0.35 gram graphite and 0.1 gram Nujol oil, mixed by grinding in a mortar/pestle for 10-15 minutes. The carbon paste mixture was packed into a Teflon cylinder electrode case and contacted with a copper wire (CH Instruments, Austin, Tex.). The counter electrode was a bright platinum wire, with a saturated calomel or Ag/Ag⁺ reference electrode completing the circuit. The glassy carbon electrodes were polished on silica lapping compounds (BDH) of decreasing sizes (0.1 to 0.05 um) on soft lapping pads, then rinsed with DI water immediately prior to use.

### Electrochemical Experiments

All experiments were typically conducted at 20±2° C. Before commencing experiments, nitrogen was used for deaeration of solutions. Stock solutions of the substituted phenols were prepared by dissolving the required substituted phenol in methanol.

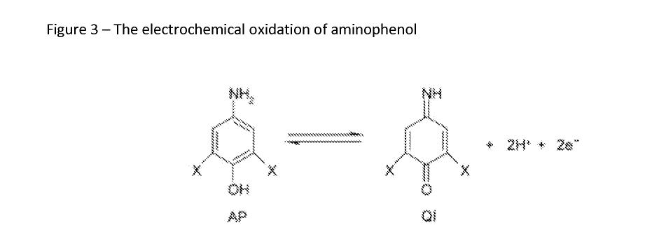

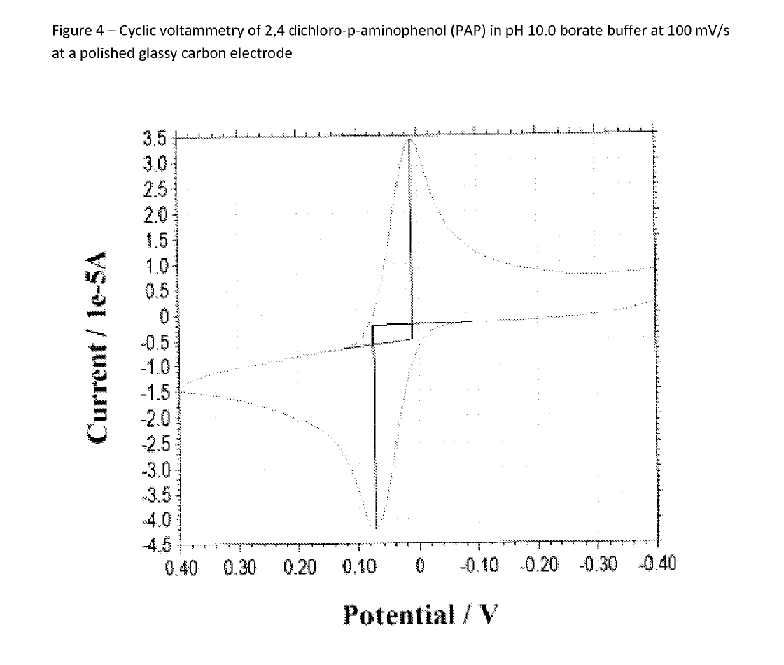

Initial Voltammetric Characterization of 4-amino-2,6-dichlorophenol (PAP). First, the voltammetric response of an Glassy Carbon electrode in pH 10 borate buffer solution (50 mM) containing 1 mM 4-amino-2,6-dichlorophenol (PAP) was demonstrated. The corresponding voltammetry is shown in FIG. 4A. The oxidation peak is observed at +0.074 V (vs. Ag/Ag⁺) with a corresponding reduction peak at +0.010V (vs. Ag/Ag⁺) which is due to the redox system of p-aminophenol-quinoneimine (PAP-QI), FIG. 3.

The response of PAP to increasing additions of phenol was measured using square-wave voltammetry (SW-voltammetry) at a carbon electrode to try to increase the sensitivity of the protocol. SW-voltammetry was used because this technique has an increased sensitivity over linear sweep (or cyclic voltammetry), due to the fact that the former is a measure of the net current, which is the difference between the forward and reverse current pulses and also using SW-voltammetry, only one peak is observed, allowing one to easily monitor the reduction of the voltammetry peak on additions of the phenol compound.

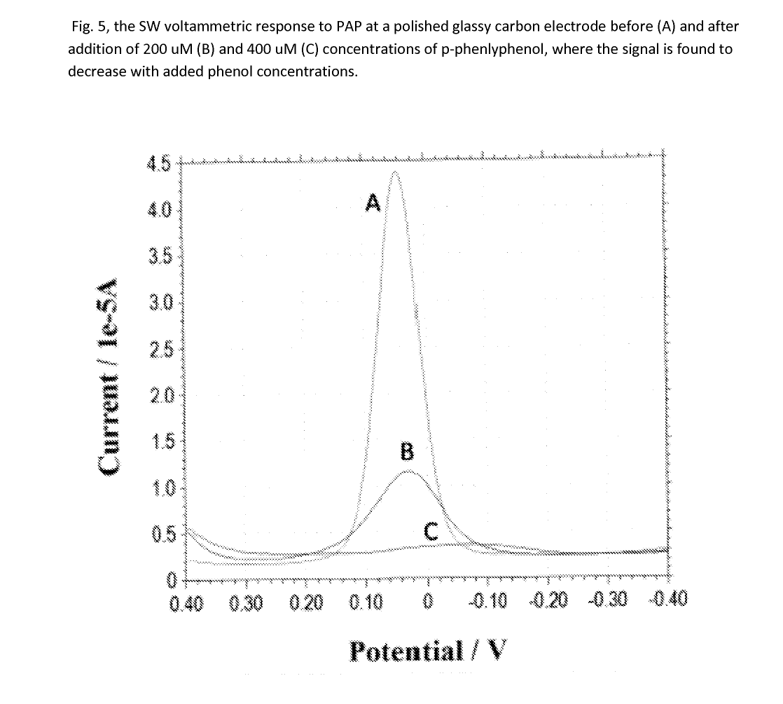

Initially, the SW parameters were optimized. Using a pH 10 buffer solution containing 1 mM PAP, the frequency and step potential were each in turn changed to find the optimum peak height; this was consequently found to occur when the frequency was 8 Hz, the step potential 4 mV and the amplitude 25 mV. Using these parameters the SW voltammetric response from an glassy carbon electrode was obtained in a pH 10 buffer solution containing 1 mM PAP. The voltammogram was cycled until the peak had stabilized, which is typically after two cycles, after which phenol additions were made to the solution. As depicted in FIG. 5, the well-defined SW voltammetric response was found to decrease with added phenol concentrations. Analysis of the peak current vs. added phenol concentration was found to be highly linear from 0 to 400 μM.

From this, a limit of detection (3σ) was found to be ˜10 μM. Note that in employing SW voltammetry, which involves holding the potential at +0.4 V for 4 s, the direct oxidation of the phenol (or phenol derivatives) is completely avoided, such that any possible electrode passivation is circumvented. This explains the slightly less favorable regression data seen using cyclic voltammetry (in comparison to SW-voltammetry), where the potential is swept into the region where phenol oxidation occurs. Thus, given the simplicity and reduced possibility of electrode fouling from using the SW-voltammetry technique, this protocol was used throughout the following work.

A control experiment was performed where identical volume sized additions were made of either water or ethanol to a pH 10 borate buffer solution containing 1 mM PAP without any phenol present. No significant reduction in the PAP voltammetric peak was observed for both the water and ethanol additions. This indicates that neither dilution effects nor reaction with ethanol were responsible for the decrease in the voltammetric response of the PAP as observed in FIG. 5; thus, the latter is purely from the Gibbs reaction of phenol with QI.

### Detection of Phenols in Aqueous Solutions at Carbon Paste Electrodes

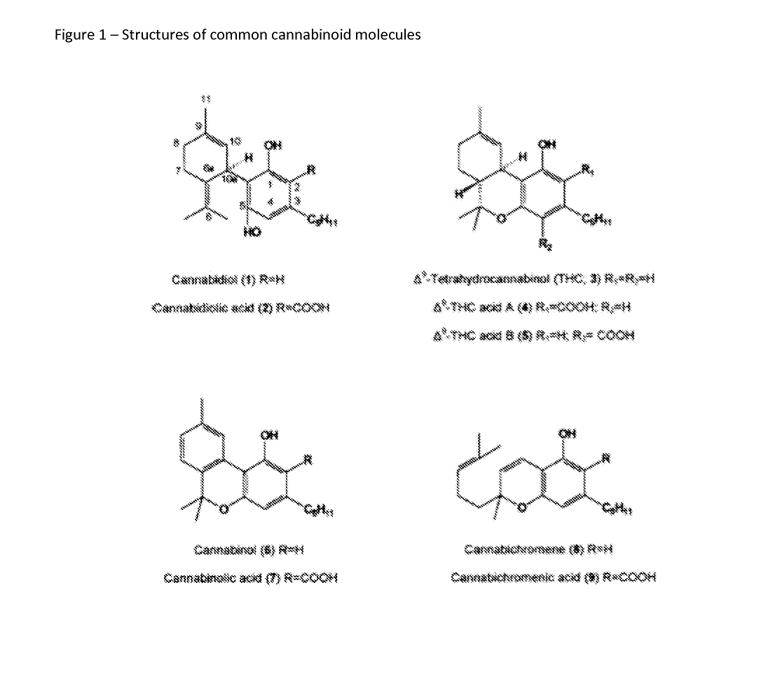

Above, we have shown a useful electrochemical methodology for the indirect determination of substituted phenol compounds. We now turn to exploring if this protocol is able to detect THC at carbon paste electrodes. The chemical structure of the latter is shown in FIG. 1, where it can be seen that it is effectively a phenol derivative which should undergo attack from the electrochemically produced dichloro-benzoquinone monoamine.

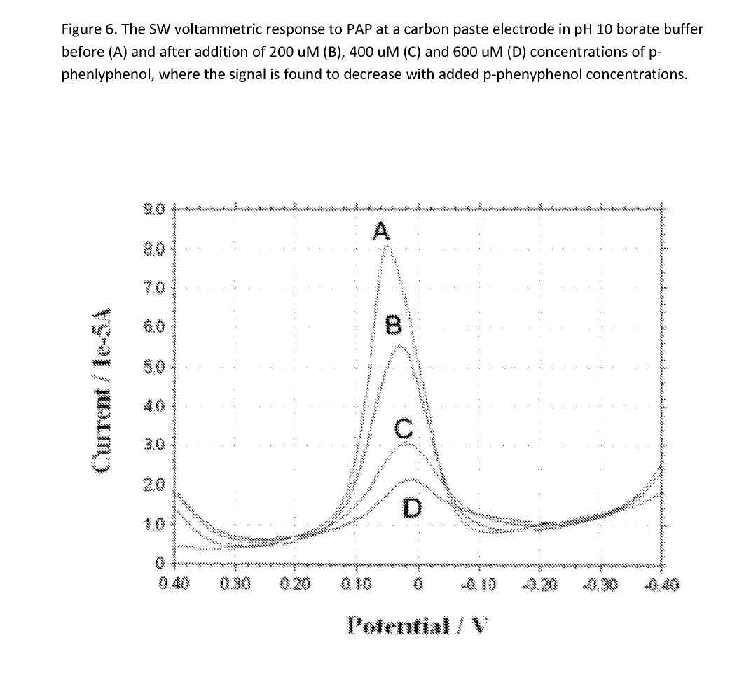

The electrochemical response at an glassy carbon electrode for the electrochemical oxidation of 1 mM PAP in a pH 10 borate buffer solution was established as shown in FIG. 4. Additions of phenol were made over the range of 100-600 μM to the solution, with the observed response depicted in FIG. 6. As observed for phenol additions described above, the reduction peak has decreased with increasing phenol additions, indicating that the protocol works as an indirect methodology for the detection of THC, the active part of cannabis. We now turn to quantify this result with SW-voltammetry.

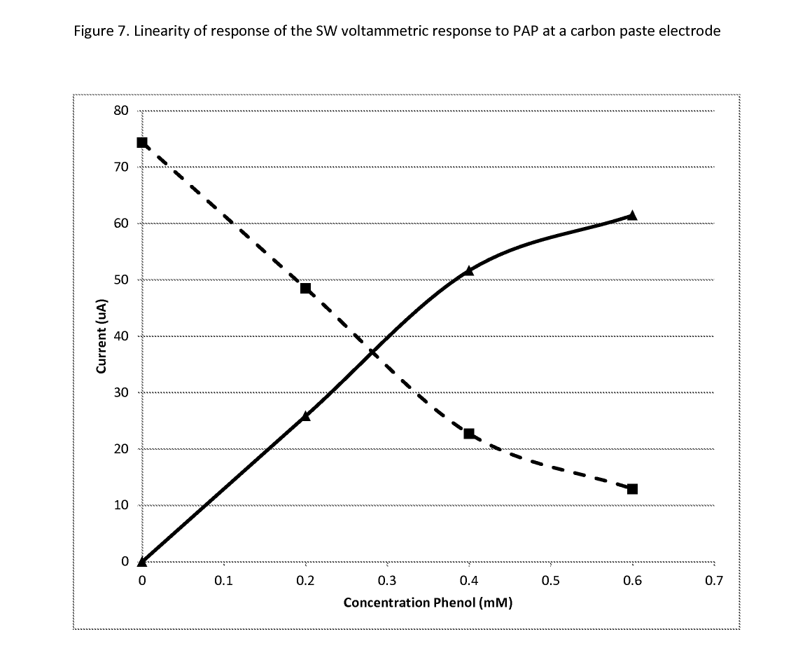

Using a 1-mM PAP solution in a pH 10 borate buffer solution, additional SW-voltammetric responses were obtained using carbon paste electrodes. The response of additions of phenol was explored. As depicted in FIG. 7, the voltammetric peak was found to decrease with increasing additions of phenol. Analysis of the peak height vs. added phenol concentrations revealed linear parts of the calibration curve. From this a limit of detection (3σ) was found to be 25 μM. While this limit of detection is not as low as previous analytical techniques (such as HPLC or gas chromatography as described in the introduction), these cannot be easily adapted to hand-held (portable) devices.

As indicated by the references cited, the detection of a variety of cannabinoid molecules should proceed in essentially the same manner. The phenolic part of the cannabinoid will undergo the same attack from the electrochemically produced dichloro-benzoquinone monoamine, and the concentration of the cannabinoid present can be inferred by the consumption of the electrochemically generated reagent. The strategy used for electrochemical detection can be selected from any of the widely known techniques, it was illustrated here with square wave voltammetry due to the convenience and availability of the instrumentation. Similar results should be obtained with a wide variety of electroanalytical techniques, including cyclic voltammetry, linear sweep voltammetry, normal pulse voltammetry, differential pulse voltammetry, chronoamperometry, chronocoulometry, sinusoidal voltammetry, ac impedance and other related methods.

The foregoing methods, devices and description are intended to be illustrative. In view of the teachings provided herein, other approaches will be evident to those of skill in the relevant art, and such approaches are intended to fall within the scope of the present invention.

We claim:

1. A sampling apparatus for releasing volatile components of a substance, said apparatus comprising;
A power supply means;
A heating means;
A temperature sensing means;
A time and temperature control means;
A sealed gas fluidic system with an optional gas supply means;
A source material holder for holding a substance of interest;
A target substrate holder for holding said target substrate;
Such that when said substance of interest and said target substrate are maintained within said sealed gas fluidic system and heat is applied to the apparatus, said time and temperature control means monitors said temperature sensing means and adjusts the heat produced by said heating means to control the temperature and the length of time heat is applied, volatile components from said material of interest evaporate or sublimate from said material of interest and are transported via the gas phase to contact said target substrate whereupon all or part of said volatile components are deposited onto said target substrate.

2. A sampling apparatus as described in claim 1 which additionally comprises at least one of the following:
a display means that displays the temperature and/or time;
an information retrieval and delivery means which is capable of transferring information regarding the sampling operation to an external observer or instrument.

3. A sampling apparatus as in claim 1, wherein said time and temperature control device varys the amount of heat applied as a function of time to produce conditions so as to allow different volatile species to evaporate or sublimate at different times.

4. A target substrate, as used in claim 1, which is composed of either a solid, or a liquid-coated solid material that has a surface with adsorptive properties, where these properties can be tailored for adsorption of specific chemical components or provide for broad adsorption of materials with general chemical characteristics.

5. An electrochemical sensor assembly for use with the sampling apparatus described in claim 1, comprising:
An electrode assembly containing multiple electrodes, at least one of which functions as a working electrode and another which functions as a reference electrode;
Optionally, a reagent strip, which may have specific reagents adsorbed therein;
Where said target substrate containing said volatile components is removed from said sampling apparatus after heating, placed in contact with said electrochemical sensor assembly and, optionally, said reagent strip, and the complete assembly is contacted with a small volume of electrolyte so as to allow electrical and solution contact.

6. An electrochemical sensor assembly as described in claim 5, wherein said small volume of electrolyte provides sufficient conductivity and solubility of the materials deposited onto the target substrate, and optionally, the reagents contained within said reagent strip, so as to allow electrochemical measurement the composition of selected chemical species within said target substrate.

7. An electrochemical sensor assembly as described in claim 5, where the chemical composition of said working electrode is modified to enhance the sensitivity of the electrochemical measurement.

8. An electrochemical sensor assembly as described in claim 5, where the chemical composition of said working electrode is modified to enhance the selectivity of the electrochemical measurement.

9. An electrochemical sensor assembly as described in claim 5, where multiple working electrodes are present, and the response of each working electrode is independent and can be associated with the concentration of one or more different component(s) contained within said target substrate.

10. An electrochemical sensor assembly as described in claim 5, where said electrochemical sensor assembly comprises:
A reagent strip contains a first compound contained within the reagent strip;
a working electrode and an electrolyte in contact with the working electrode, wherein the first compound operatively undergoes a redox reaction at the working electrode to form a second compound which operatively reacts in situ with the adsorbed volatile sample;
wherein said redox reaction has a detectable redox couple and wherein the sensor is adapted to determine the electrochemical response of the working electrode to the consumption of said second compound on reaction with the adsorbed volatile sample.

11. An electrochemical sensor assembly as described in claim 6, wherein said adsorbed volatile component(s) are electroactive and can be measured directly by oxidation or reduction at the working electrode.

12. A sampling apparatus as in claim 2, wherein said information retrieval and delivery means is chosen from the group consisting of a USB interface, firewire, Ethernet, fiber optic, wireless Ethernet, iLink interface, NY interface, telephone cable interface, parallel interface, or serial interface.

13. The apparatus of claim 2 where said information retrieval and delivery means is interfaced to a computer or microcontroller to control operation and/or receive data concerning its operation.

14. The apparatus of claim 13, where control operations are encoded within the computer and/or microcontroller, such that no user input is required for operation.

15. The apparatus of claim 13, where the computer and/or microcontroller are connected to a remote computer or microcontroller, such that operation of the apparatus is controlled by the remote system.

16. A database constructed from data obtained from the apparatus described in claim 13; where such database consists of information gathered by tracking the results of the user engaging the sensor with a plurality of samples, including the determination of multiple chemical components within a given sample.

17. The target substrate described in claim 4, where said target substrate uses an encoded physical medium. The encoded physical medium is suitable for having at least one region wherein information has been encoded with sample information.

18. The sampling apparatus described in claim 2, where the sample and/or target material holders include a second device responsive to the first device such that when the first device determines the presence of the specified content, the second device is operable to decode the certain encoded information present in the measured information.

19. The sampling apparatus described in claim 2; where the sample container and/or target substrate also contains a transmitter device operable to transmit the certain decoded information to a computer system.

20. A sample kit for use with sampling apparatus as described in claim 1, comprising:
A sample cell, to contain said material of interest and which is insertable into said sample holder;
A target substrate, insertable into said target substrate holder;
Optionally, an electrode assembly for sensing components deposited on said target substrate;
Optionally, a reagent strip containing chemicals required for operation of said sampling device;
Operating instructions.
